(19) United States
(12) Patent Application Publication
(10) Pub. No.: US 2017/0243260 A1
(43) Pub. Date: Aug. 24, 2017

(54) CUSTOMER SERVICE SYSTEM

(71) Applicant: RENE NATHAN, LOWER TEMPLESTOWE (AU)

(72) Inventor: RENE NATHAN, LOWER TEMPLESTOWE (AU)

(21) Appl. No.: 15/503,753

(22) PCT Filed: May 27, 2015
(86) PCT No.: PCT/AU2015/050286

§ 371 Date: Feb. 14, 2017

Related U.S. Application Data
(60) Provisional application No. 62/004,389, filed on May 29, 2014.

(51) Int. Cl. G06Q 30/02; G06Q 30/00; G06Q 10/06

(52) U.S. Cl. CPC G06Q 30/0281; G06Q 10/06398; G06Q 10/063112; G06Q 30/016

(57) ABSTRACT

The present invention provides a system for transmitting a customer need message to a target member of an organization, the system comprising: a first processor-enabled device configured to create the customer need message, a second processor-enabled device configured to receive the customer need message, a database comprising: (i) contact details for a plurality of members of an organization, the plurality of members being potentially capable of or responsible for addressing the customer need, and (ii) for each of the plurality of members of the organization, one or more customer need capabilities, wherein the system is configured such that, in use, a string of the customer need message is used to interrogate the database to identify a target member of the organization capable of or responsible for addressing the customer need, and the customer need message is transmitted to the target member capable of or responsible for addressing the customer need.

### FIELD OF THE INVENTION

The present invention is direct to systems and methods for the management of customer enquiries to an organization.

### BACKGROUND TO THE INVENTION

Large organizations have significant numbers of customers, including potential customers. On any given day an organization may receive an enquiry or other from thousands of customers. The communication may be in the form of a telephone call, an email, a web page form, a text message, or any other means.

Typically, the customer or potential customer initially communicates with a first point of contact, that contact often being a customer service person whose main role is to direct the customer to another person in the organization capable of or responsible for assisting with the customer's need. Often, this first point of contact is a contact centre telephone operator, or a person charged with reviewing incoming written communication such as email enquiries.

The challenge before the first point of contact is to a select person within the organization best suited to deal with the customer's need, and to then hand the customer over to that person. Larger organizations typically have hundreds or many thousands of staff from which the first point of contact may choose. In that selection process the first point of contact generally asks the customer a series of questions (which may or may not be scripted) in order to better define the need, and therefore the best person in the organization to address that need. Sometimes, the structured question approach does not lead to a result, or the customer may simply wish to directly articulate their need. In any event, the selection processes can be time consuming for the first point of contact and the customer. Many customers also become irritated by the need to answer multiple questions in order to have their need addressed.

On many occasions, the process of selecting the member suited to address the customer's need is not successful. This typically becomes apparent when the initial point of contact tries to handover the customer (for example, the selected member may advise the first point of contact that he/she is unable to address the need) or in the course of further communication between the customer and the selected member. In that case, there is a second handover event, with the customer being passed to a third member of the organization who may be better suited to address the need.

The customer may not be aware of the handover, especially where the enquiry is written. While the customer is not aware of the handover, there is an efficiency deficit to the organization given that the time of two employees has been taken up by the enquiry.

For a telephone enquiry, the customer will be aware of the handover by needing to discuss the need with multiple members of an organization. This leads to irritation of the customer, as well as the efficiency deficit to the organization as discussed above. Where the customer experiences multiple handover events, the problems of customer irritation and efficiency deficit are further compounded.

It is an aspect of the present invention to overcome a problem of the prior art to provide improved systems and methods for attending to customer enquiries, or to provide a useful alternative to systems and methods of the prior art.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### BRIEF DESCRIPTION OF THE DRAWINGS

FIG. 1 is a diagram of a process flow of a preferred embodiment of the invention.

### SUMMARY OF THE INVENTION

In a first aspect, but not necessarily the broadest aspect, the present invention provides a system for transmitting a customer need message to a target member of an organization, the system comprising: a first processor-enabled device configured to create the customer need message, a second processor-enabled device configured to receive the customer need message, a database comprising: (i) contact details for a plurality of members of an organization, the plurality of members being potentially capable of or responsible for addressing the customer need, and (ii) for each of the plurality of members of the organization, one or more customer need capabilities, wherein the system is configured such that, in use, a string of the customer need message is used to interrogate the database to identify a target member of the organization capable of or responsible for addressing the customer need, and the customer need message is transmitted to the target member capable of or responsible for addressing the customer need.

In one embodiment of the system, the customer need capabilities include one or more of: a product and/or service specialty, a technical skill, experience, knowledge, a qualification, a language spoken and/or written, a location, and a service rating.

In one embodiment of the system, the database comprises 2, 3, 4, 5, 6, 7, 8, 9, 10 or more customer need capabilities for at least one of the plurality of members on the database.

In one embodiment of the system, the database comprises 2, 3, 4, 5, 6, 7, 8, 9, 10 or more customer need capabilities for most or substantially all of the plurality of members on the database.

In one embodiment of the system, the interrogation of the database is for a combination of any 2, 3, 4, 5, 6, 7, 8, 9, 10 or more customer need capabilities.

In one embodiment of the system, the database comprises contact details and customer need capabilities for at least 100, 200, 300, 400, 500, 1000, 5000, 10000, 50000, 100000 or 200000 members.

In one embodiment, the system is configured to be operable so as to be devoid of a handover event.

In one embodiment the system is configured to be operable so as to require no more than one handover event

In one embodiment of the system, the customer need message comprises a text string.

In one embodiment of the system, the customer need message comprises free text entered by a customer, or a customer assistant.

In one embodiment of the system, the customer need message is in the form of an email, a web page enquiry, voice, or a text message.

In one embodiment of the system, the interrogation step is performed by reference to the free text entered by the customer or customer assistant.

In one embodiment of the system, the system is configured to allow the rating of the target member capable of or responsible for addressing the customer need.

In second aspect, the present invention provides a computer-implemented method for transmitting a customer need message to a target member of an organization, the method comprising the steps of: providing a first processor-enabled device configured to create the customer need message, providing a second processor-enabled device configured to receive the customer need message, providing a database comprising: (i) contact details for a plurality of members of an organization, the plurality of members being potentially capable of or responsible for addressing the customer need, and (ii) for each of the plurality of members of the organization, one or more customer need capabilities, transmitting a customer need message from the first processor-enabled device to the second process-enabled device, interrogating the database with a string of the customer need message to identify a target member of the organization capable of or responsible for addressing the customer need, and transmitting the customer need message to the target member of the organization capable of or responsible for addressing the customer need.

In one embodiment of the method, the customer need capabilities include one or more of: a product and/or service specialty, a technical skill, experience, knowledge, a qualification, a language spoken and/or written, a location, and a service rating.

In one embodiment of the method, the database comprises 2, 3, 4, 5, 6, 7, 8, 9, 10 or more customer need capabilities for at least one of the plurality of members on the database.

In one embodiment of the method, the database comprises 2, 3, 4, 5, 6, 7, 8, 9, 10 or more customer need capabilities for most or substantially all of the plurality of members on the database.

In one embodiment of the method, the interrogation of the database is for a combination of any 2, 3, 4, 5, 6, 7, 8, 9, 10 or more customer need capabilities.

In one embodiment of the method, the database comprises contact details and customer need capabilities for at least 100, 200, 300, 400, 500, 1000, 5000, or 10000 members.

In one embodiment, the method is devoid of a handover event.

In one embodiment, the method requires no more than one handover event.

In one embodiment of the method, the customer need message comprises a text string.

In one embodiment of the method, the customer need message comprises free text entered by a customer, or a customer assistant.

In one embodiment of the method, the customer need message is in the form of an email, a web page enquiry, voice, or a text message.

In one embodiment of the method, the interrogation step is performed by reference to the free text entered by the customer or customer assistant.

In one embodiment, the method comprises the step of the customer rating the target member capable of or responsible for addressing the customer need.

### DETAILED DESCRIPTION OF THE INVENTION

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

The present invention is predicated at least in part on Applicant's finding that customer needs may be more efficiently addressed by limiting or completely removing the requirement for a customer to firstly communicate with one or more persons within an organization before their need is considered by a person within the organization who is capable of or responsible for addressing the need.

Accordingly, in a first aspect the present invention provides a system for transmitting a customer need message to a target member of an organization, the system comprising: a first processor-enabled device configured to create the customer need message, a second processor-enabled device configured to receive the customer need message, a database comprising: (i) contact details for a plurality of members of an organization, the plurality of members being potentially capable of or responsible for addressing the customer need, and (ii) for each of the plurality of members of the organization, one or more customer need capabilities, wherein the system is configured such that, in use, a string of the customer need message is used to interrogate the database to identify a target member of the organization capable of or responsible for addressing the customer need, and the customer need message is transmitted to the target member capable of or responsible for addressing the customer need.

The present system decreases the number of, or may obviate altogether, customer handovers. As will be understood, the term “customer handover” in the context of this invention means the transfer of customer need from a first member to a second member of an organization. In some embodiments, the system allows for the implementation of a “straight through” method of addressing customer needs, whereby the customer is put in direct contact with a member capable of or responsible for addressing their need.

A further advantage of the present invention is that the amount of time required for the customer to articulate his or her need, and/or the amount of time required for staff of an organization to identify the person within the organization who is capable of or responsible for addressing the customer's need may be decreased.

As used herein, the term “member” is intended to be construed broadly to include the following: a full-time employee of an organization, a part-time employee of an organization, a contractor to an organization, a consultant to an organization, a licensee, a franchisee and a volunteer.

As used herein, the term “organization” is intended to be construed broadly to mean any collection of individuals in the pursuit of one or more common goals. The organization may be for profit or not-for-profit, privately owned, publicly owned, or a government organization. Preferably, the organization is a commercial organization for profit. Given the problem of addressing customer needs in larger commercial organizations, the invention is particularly applicable to organizations having at least about 1000, 2000, 3000, 4000, 5000, 6000, 7000, 8000, 9000, 10000, 15000, 20000, 25000, 30000, 35000, 40000, 45000, 50000, 60000, 70000, 80000, 90000, 100000, 110000, 120000, 130000, 140000, 150000, 160000, 170000, 180000, 190000 and 200000 personnel. Preferably, the organization has at least about 50000, more preferably more than about 100000 personnel. Greater advantages are proposed for very large organizations given the very significant problems of handling client enquiries in such establishments. In some embodiments, the organization has less than about 500000, 400000, 300000, 200000 or 100000 personnel.

Given that the customer is external to the organization to which the need is directed, the system is typically implemented at least in part across a computer network such as the Internet. In that circumstance, the first processor-enabled device at least is configured to be operably connectable to the Internet. The first processor-enabled device may be a personal computer, a lap top, a tablet, a phablet, or a smart phone. In some embodiments, the first processor-enabled device is configured as a self-serve kiosk which may be located within a store of the organization or a public area of a shopping mall.

The second processor-enabled device may or may not be configured to be operably connectable to the Internet, and may be a part of a WAN or LAN of the organization. In that circumstance a member of the organization (and typically a primary contact, such as a receptionist, customer assistant or contact centre operator) enters the need message into a WAN or LAN connected computer of the organization, that computer being the second processor-enabled device of the system.

The present systems facilitate the direction of a customer need message with a member of an organization capable (or at least potentially capable) of addressing that need. The present systems are distinguished from prior art systems in that the customer may be put into direct contact with the relevant member of an organization, there being no absolute requirement for the customer to interact with any member of an organization who is not capable of or responsible for assisting the customer. This is of assistance to the customer because of the decrease in handover events required to have his or her need addressed, and negates the need to discuss the need with multiple members of an organization before being put in contact with a person who can actually deal with the need.

For example, the customer may transmit an email stating a need to a central enquiry email address of an organization. By the present systems, the content of the email (or even just the subject line) is used by the system to identity a target member of the organization capable of or responsible for addressing the customer's need. The customer is then put directly into contact with the target member. As another example, the customer telephones a primary contact person in an organization, and discusses his or her need. The primary contact then generates a customer need message on a computer (being the first processor-enabled device) and then transmits the message to the system.

Moreover, the present invention is an improvement on prior art systems where the customer is unaware that their message has been routed to intermediate members before being considered by a person who is capable of or responsible for addressing the need. The reduction in time taken by members in passing a customer enquiry from one member to the other is advantageous to the organization.

In one embodiment, the customer need message is generated in total or in part by the customer selecting an appropriate option from a number of predetermined categories placed before him or her by a customer interface. The predetermined categories are typically devised by the organization in consideration of the likely needs of their customers, and with a view to segmenting their member base into relevant groups. Taking for example a telecommunications company, one category presented may be “new or business or personal”, the customer selecting the category for which their need applies. Where “business” is selected, the customer need message is tagged and/or directed accordingly, and the message will be transmitted only to a member who is capable of or responsible for addressing the needs of a business customer.

Further selections for more accurately defining the need (and therefore the target capable or responsible member) may be presented to the customer. For example, the telecommunications company customer may be presented with the options “buy”, “install”, “fix”, “complain”, “enquire” and “accounts/administration”. Where the customer selects “buy” for example, the customer need message is tagged and/or directed accordingly, and the message will be transmitted only to a member who is a sales person.

The interface may present further categories relevant to the “buy” category, such as “pre-paid cell phone”, “modem”, “tablet”, and “pay TV”. By selecting the “pay TV” option the customer need message is accordingly, is transmitted and/or directed only to a member who has knowledge of pay TV plans.

By this process, the subpopulation of members capable of or responsible for addressing the customer's need is significantly narrowed. In some circumstances, this process is sufficient to identify a member or group of members who are likely to be capable of or responsible for addressing the need. Where a single member is identified, the customer need message is transmitted to that member. Where a group of members is identified, the message may be transmitted to a member of the group who is free to deal with the need, or the first member to become free.

In addition to the selection of categories as described supra, or as an alternative to that process, the customer need message may be generated in total or in part by free text or speech provided by the customer.

Where the message is verbal, the message may be transmitted by telephone or the Internet (such as a Skype™ call) to the organization by way of a first point of contact such as a customer assistant including a contact centre operator of the organization, or an assistant in a shop operated by the organization or a licensee or franchisee of the organization. This first point of contact functions to an extent as a customer assistant, by acting as an intermediary between the customer and the system. The first point of contact may then enter the message into the system as a written customer need message. Alternatively, speech recognition software may be included in the system to convert a verbal message to a written message which is subsequently processed as discussed infra.

Where the message is written, the message may be transmitted to the organization electronically in the form of an email, web page enquiry form or an SMS text message. The written, electronic message may be handled without human intervention, and directly utilized by the system for the database interrogation.

Irrespective of the form of the customer message, the message may be processed by way of an algorithm(s) to extract words, word fragments, sentences, sentence fragments, and with references to a predefined taxonomy and/or dictionary in order to identify potentially useful strings by which the database is interrogated. The algorithm(s) typically involves the weighting of words to assist in the correct interpretation of the message. For example, words such as “buy”, “install”, “broken”, “account” and the like may be highly weighted as such words are likely to be useful in routing the message to a target member. Words such as “phone”, “battery” and “service” have broad applicability across many areas of a telecommunications company and may therefore be afforded a lower weight in any algorithm(s) configured to match a customer need message with a target member.

As will be clear from the paragraph supra, as used herein the term “match” (and related terms such as “matched”, “matching” and the like) should not be construed narrowly to mean only a strictly binary test. While this construction is included, the term “match” is also intended to refer to non-binary tests. As will be appreciated, the present systems involve a determination as to which member of an organization is better suited to address a particular client need, as distinct from simply determining which members are suited and which members are not suited. Accordingly, the matching may involve the weighting of various words or terms considered in the matching algorithm(s), the weighting determined by the organization in designing the algorithm(s). Other matching means such as fuzzy logic, approximate string searching, conceptual string searching and the like will be useful in the context of the present invention, especially where matches are made with free text input by a customer, of the text of a member's curriculum vitae and other attributes and associated attributes in the system which may be used to define a member's capabilities.

In other embodiments of the system, there is minimal or no processing of the message. For example, the raw message may be simply divided into its component words, with each word being used as search term for the database interrogation. Whole sentences or sentence fragments may be divided in portions of several words where contextual analysis of text is available.

The message may comprise information that has not been explicitly provided by the customer. For example, previously stored details for a customer may be retrieved from a server of the organization and form part of the message, or be otherwise attached to the message. A customer may have previously registered with an organization (and provided details in the process) and have a login access to a web page of the organization. Upon login, the customer may complete a web page enquiry form, and so the information associated with the customer (such as location, age, whether a business or domestic customer, whether a premium or non-premium customer, which products have been purchased etc) is included in the need message and therefore usable as a search term in the database interrogation. Alternatively, the information that has not been explicitly provided is not included in the message per se, but is otherwise included in the database interrogation via separate means.

In one embodiment, the first processor-enabled device (as used by the customer) may be location-enabled (for example, by GPS means), with this information automatically included in the need message. Accordingly, only organization members within a given geographical zone may be matched to the customer.

As another example, a client may telephone an organization but must first enter an account number or a customer number (optionally with a password). When the initial point of contact answers the call and prepares the customer needs message for processing by the system, the system firstly includes information held by the organization on that customer, either visibly or in background, in the needs message. The initial point of contact augments that basic information with free text relating to the customer's particular need.

The database of the system holds customer need capabilities on members of the organization, that information being utilized by the system to match a client need to a member capable of or responsible for addressing the need. Member information useful in this context is not limited in any way to the particular types of information disclosed as potentially useful in the present specification.

An exemplary customer need capability includes a product speciality or a service specialty. Typically, these specialties are determined by the organization.

Where the customer need message has been generated by the selection of predetermined need categories (as described supra) it is preferred that the customer need capabilities are categorised similarly to form matches between categories and capabilities. This allows for a direct routing of message to target member. For example, where the need categories from which the customer may select are “buy”, “install”, “fix”, “complain”, “accounts”, the matched customer need capabilities potentially assignable to a member may be “sell”, “arrange installation”, “arrange repair or spare parts”, “handle complaints” and “handle account enquiries”.

By this deliberate matching of customer enquiry category with customer needs capability category, the system is capable of or responsible for routing a customer need message to a member who is at least likely to be of assistance to the customer.

While systems incorporating the use of matched need categories and need capabilities will be effective in routing customer need messages, further advantage may be gained where free text or speech generated by the customer and forming part of the needs message (or attached to the need message) is utilized to improve the matching of a need message with a target member. It will be appreciated that the use of categories will typically identify a group of members (and possibly hundreds of members), and that further refinement may be desirable or necessary by reference to the free speech or text.

Taking again the example of the telecommunications company, the use of enquiry categories with matched capability categories may allow for the need to be broadly identified as the purchase of a smartphone. The use of matched capabilities will direct the needs message to any person within a large group of cell phone sales members. However, the client may have included free text stipulating a preference for an Android™ smartphone, and furthermore one having the “ice cream sandwich” operating system or higher. Accordingly, the system will seek to match the needs message to a member having expertise in the Android™ operating system who is more likely to understand the terminology “ice cream sandwich” than a member more familiar with iOS phones.

As will be understood, however, free text or speech generated by the customer may be used alone. For example, a first member of a telecommunications company may be specialized in mobile phone products and services, while a second member is specialized in home internet services. Thus, needs messages including words such as “calls”, “plan”, “roaming”, “txt”, “international”, “4G”, “handset” and the like are transmitted by the system to the first member, while messages including words such as “IP”, “kb/s”, “modem”, “wireless”, “GB” and the like are transmitted to the second member. Separate to the utility of matching a customer need message to a target member, free text or free speech may serve a further purpose in so far as the customer is not required to restate their need in the course of a handover event. Furthermore, in the course of entering the free text or articulating their need verbally, the customer may be caused to more fully consider their need, and is therefore more likely to include relevant information in the customer need message.

In some embodiments, the customer need capability relates to a location of the member. This may be a primary factor considered by the system algorithm(s), given the need for co-location of the customer and target member for certain types of need. For example, where the need relates to a product installation the fact the target member is in the same city as the customer may be important given the need of the member to communicate with workmen in real time and in the same time zone. However, location will typically be unimportant for a complaint need given the lack of relevance of location.

As an example, where the organization is a computer company a first member may be present in New York City, and a second member present in Los Angeles. Thus, needs messages which include a word such as “NY”, “Brooklyn”, or “Queens” and the like are transmitted to the first member, while messages which include a word such as “LA”, “Malibu”, “Santa Monica” and the like are transmitted to the second member.

In some embodiments, the customer need capability relates to a technical skill. As an example, where the organization is a contract pharmaceutical manufacturing company a first member may be skilled in microbial fermentation, and a second member skilled in sterilization. Thus, needs messages including words such as “protein”, “expression”, “medium”, “bacteria” and the like are transmitted to the first member, while messages including words such as “ionizing”, “cfu”, “ultraviolet”, “pasteurization” and the like are transmitted to the second member.

In some embodiments, the customer need capability relates to experience. As an example, where the organization is a legal firm a first member may have experience in contentious matters, and a second member experienced only in non-contentious matters. Thus, needs messages including words such as “deposition”, “sue”, “plaintiff”, “damages” and the like are transmitted to the first member, while messages including words such as “agreement”, “mediation”, “due diligence”, “license” and the like are transmitted to the second member.

In some embodiments, the customer need capability relates to knowledge. As an example, where the organization is a computer retailer a first member may have knowledge of hardware matters, and a second member knowledge only of software. Thus, needs messages including words such as “chip”, “RAM”, “bus”, “PCB” and the like are transmitted to the first member, while messages including words such as “version”, “debug”, “OS”, “multi-user license” and the like are transmitted to the second member.

In some embodiments, the customer need capability relates to a qualification. As an example, where the organization is a construction company a first member may have a qualification in engineering, and a second member a qualification in landscape architecture.

Thus, needs messages including words such as “civil”, “construction”, “B.Eng”, and the like are transmitted to the first member, while messages including words such as “design”, “B.Arch”, “landscape” and the like are transmitted to the second member.

In some embodiments, the customer need capability relates to a language spoken or written. As an example, where the organization is a stationary company a first member may be fluent in French, and a second member fluent in German. Thus, needs messages including any French word (or just stationary-specific words such as “stylo”, “papier, or “regle” and the like) are transmitted to the first member, while messages including any German word (or just stationary-specific words such as “kugelschreiber”, “papier”, “herrscher” and the like are transmitted to the second member. In this example, it will be noted that the French and German words for “paper” are the same. In that situation, the needs message could be transmitted to either the first or second member, or both members. To identify the more appropriate member, the system may be configured to consider a second word (or even further words) to identify the language origin of the majority of words.

In some embodiments, the customer need capability relates to a rating of the member. The rating may be one generated by customer feedback of the present system, or by any other means. As an example, where the organization is a courier company, a first member may have a high rating which is indicative of efficiently dealing with urgent logistic matters, and a second member having a high rating in dealing in more complex logistics planning matters that are not time sensitive. Thus, needs messages which include a word such as “deadline”, “quickly”, or “without delay” and the like are transmitted to the first member, while messages which include a word such as “strategy”, “quotation”, “forecast” and the like are transmitted to the second member.

As discussed supra, the matching algorithm(s) of the system may differentially weigh the skills, experience, knowledge, qualifications, language and rating of a member to provide for improved outcomes. As an example, language may be accorded a high weight because no matter how relevant a member's knowledge to the customer need, the need is unlikely to be properly addressed due to communication difficulties. Conversely, a member's previous role in an organization may be accorded a low weighting given that the member's present role is more predictive of his or her ability to properly assist a customer.

In one embodiment of the system the customer need capabilities held by the database are obtained by structured means, rather than simply allowing members to freely enter (or not enter) information.

The structured nature of the customer need capabilities of the present systems may arise from the information being obtained from members by a method which is at least partially controlled by the organization. Intervention by the organization is proposed to increase the completeness and/or reliability of the customer need capabilities held in the database.

The method of obtaining customer need capabilities may comprise presentation of the one or more member(s) of the organization with a structured questionnaire. The questionnaire may be administered in any convenient format. In one embodiment the structured questionnaire is presented to a member in the course of an interview, for example during an induction process. A member of the human resources department may pose a series of predetermined questions in order to increase the likelihood of eliciting information which may be of use to the organization.

More typically, the structured questionnaire is presented to personnel in the context of a web browser, or similar format. Entry of information can be elicited in a highly structured manner, with the answer to a question directing subsequent line(s) of questioning. As an example, a first question may relate to the skills in which a marketing professional has practical expertise: internet; television, print media, or radio. Where the answer is “internet” a specific group of sub-questions may be posed, requesting whether the internet marketing expertise is in the field of web page design, content, analytics, running alternative campaigns etc. Such sub-questions will be irrelevant to a marketer having experience only in print media, for example. It is proposed that this method of guided questioning can result in superior quality of information given that members can more fully respond to only more relevant questions.

The method of obtaining information from the one or more personnel of the organization may be computer-implemented, and optionally incorporated into the present systems.

In one embodiment, the structured questionnaire is presented to the members of the organization at the commencement of employment and/or at regular intervals during employment. The system may comprise means for automatically forwarding reminder correspondence to members (such as by email) in a periodic manner, prompting members to update customer need capabilities.

In one embodiment, the one or more question(s) of the set of predetermined questions is presented with a set of multiple choice answers. It is proposed that significant advantage is obtained given that highly structured (and therefore easily searchable) information is generated where personnel have only a limited number of options from which to select in answering a predetermined question.

In addition or alternatively, the method of eliciting information from members may involve unstructured means and may include an automated analysis of free text. For example, a member curriculum vitae, a job description (previous or present), a file held by the organization human resources department may be used. The raw free text or analysed capabilities may be validated by a nominated or suitably qualified person before being used as a customer need capability in the present systems.

It will be appreciated that given the benefit of the present disclosure, the skilled person will be capable of or responsible for generating various taxonomies, dictionaries, syntaxes, and the like useful in a particular organization having regard to the products or services concerned.

It will be appreciated that significant advantage will be gained where multiple customer need capabilities are included in the database for each member. The specific combination of capabilities provides a “capability profile” for each member of an organization, thereby providing a greater opportunity for a customer need to be transmitted to a member who has the combination of capabilities required to best address a customer need. To that end, it is proposed that incremental advantage is provided by each additional customer need capabilities added to each member of the organization.

New capabilities can be added by the organisation by being either entered by the customer or by a member. The system identifies the new term or terms or strings of words, notifies or reports on these new capabilities, and these can be incorporated or not incorporated in the system at the discretion of the organisation.

Moreover, advantage is gained where the system is configured such that the database may be interrogated with reference to multiple customer need capabilities.

Of course, to more effectively match the customer with a target member, the customer need message should provide a useful number of words, terms, sentences and the like. Where the message has minimal content, it is likely that a customer will be matched to a large number of members, some of whom will be able to address the need very well, but most not.

For example, a customer need message transmitted to a telecommunications company may minimally recite: “I've just moved and need an internet connection”. A more complete message may recite “I've just moved to Sydney and need a high speed internet connection for my small business. I will also need two telephone lines, one of which will be dedicated to the internet connection.”

The first message might be transmitted to a subgroup of all staff members who deal in new internet connections. However there may be several hundred members who deal in new internet connections in the organization, and it is unlikely that any one member is unlikely to be a suitable match for the customer, but only because the customer has not provided sufficient information in the customer needs message.

However, the greater number of search criteria provided by the text of the more complete message recited supra could be utilized to target a staff member who is (i) located in Sydney, (ii) deals with new internet connections, (iii) has particular expertise in business solutions, and (iv) who is also familiar with the requirements for setting up new land lines.

It is therefore preferred that the system is configured to allow or encourage a customer to provide more than minimal input. This may be achieved by a prompt on the user interface of the first processor-enabled device which suggests the customer revise the message to include further information if a very short message is transmitted.

Alternatively, a large window may be provided on the user interface to encourage the input of multiple lines of free text. The window may provide a warning for the customer to provide as much information as possible.

As a further example, the customer message input may be monitored in real time by the system, and prompts the customer as he or she is typing if important information is left out. For example, the customer might input free text that he or she is located in Sydney but in further free text entered does not qualify which suburb of Sydney. At that point, a prompt may appear reminding the customer to insert this information.

In some embodiments of the system, the customer is compelled to provide information in the customer need message by way of a fillable field, check box, radio button, drop down menu and the like. This information may be in place of free text, or additional to free text. These approaches ensure that basic information such as location, product type, service type etc are included in a need message.

In some embodiments, the system is configured to transmit a customer need message to two or more target members. Taking the example of the telecommunications company supra, a first member may specialize in business internet plans, while a second member in landline telephone connections. However, the system is typically configured such that a single member has an overall responsibility for ensuring the completion of all actions required to address the customer need and is therefore accountable for the satisfaction of the customer.

As is discussed elsewhere herein, some embodiments of the system are configured to allow a customer to rate the organization's performance and in those embodiments that rating will be accorded to the member with overall responsibility and accountability.

Once matched to a target member, the customer need message is transmitted to that member. The database comprises a contact detail of the member, this being an email address in some embodiments. In other embodiments the system does not rely on email communication and may deliver the message to an electronic display (such as an electronic dashboard) on the target member's computer. The contact detail may also be a cell phone number, allowing contact by telephone call, SMS text message, or voicemail.

The system may be configured to allow the rating of a target member after that member has addressed, or attempted to address the customer need. This feedback may in turn be used as a customer need capability. Feedback may be obtained by an automatic email or SMS text message sent by the system to the customer.

If the message is not accepted by a member, or the member is not available, or the member is not available within an acceptable time, the need message may be automatically directed to another member having the same or similar capabilities. The system may be configured to also transmit a message to a manager in this circumstance.

It will be appreciated that the target member may not have a responsibility for directly attending to any task required to address the customer need (for example visiting premises to install a product), but will have a responsibility for organizing any task and generally overseeing the need. In that circumstance, the target member having the responsibility for organizing the tasks required is rated.

In one embodiment, the system is configured to report ratings on organization members, this allowing for the analysis of organization and member performance in addressing customer needs. The system may also be configured to track and report the progress of a customer need message from the time it is received until the time the customer leaves a feedback rating. By this configuration, the performance of the system and/or the organization and/or individual member for a particular customer need can be monitored by management.

In another embodiment the system is configured to track the progress of the customer need, with the progress (or lack of progress) affecting the member rating. For example, the organization may have an established high level process and optionally various rules and guidelines for the handling of a customer need. Such rules may include a time period within which certain actions must be undertaken (for example responding to the customer within 1 hour) or certain guideline questions that may be asked of the customer (such as whether an installer attended the premises on time). The system may be configured such that the member having responsibility for the customer need is required to enter the completion of certain tasks and the customer answers to any questions in order to provide a summary for a manager to review performance.

The present systems may be configured to accumulate data on each customer, and optionally export customer data for accumulation in a database such as a customer relationship management system or a customer management system. In addition or alternatively, the systems may be configured to accumulate data on each member of the organization, and optionally export customer data for accumulation in a human resources database. By these embodiments, data on the entire organization with regard to customer service and/or employee performance may be generated and analysed by organization management

In a further aspect, the present invention comprises a computer-implemented method for transmitting a customer need message to a target member of an organization, the method comprising the steps of: providing a first processor-enabled device configured to create the customer need message, providing a second processor-enabled device configured to receive the customer need message, providing a database comprising: (i) contact details for a plurality of members of an organization, the plurality of members being potentially capable of or responsible for addressing the customer need, and (ii) for each of the plurality of members of the organization, one or more customer need capabilities, transmitting a customer need message from the first processor-enabled device to the second process-enabled device, interrogating the database with a string of the customer need message to identify a target member of the organization capable of or responsible for addressing the customer need, and transmitting the customer need message to the target member of the organization capable of or responsible for addressing the customer need.

The various embodiments and examples described elsewhere herein with regard to the present systems are applicable also to the methods of the invention. For the sake of clarity and brevity, the embodiments and examples described with regard to the systems will not be repeated at this point in the specification. However, those embodiments as they apply to the methods are incorporated herein at this point of the specification by reference.

One embodiment of the systems and methods described herein is in the form of a computer-readable carrier medium carrying a set of instructions, e.g., a computer program for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method as described herein. Accordingly, aspects of the present invention may take the form of a method, an entirely hardware embodiment, an entirely software embodiment or an embodiment combining software and hardware aspects. Furthermore, the present invention may take the form of a carrier medium (e.g., a computer program product on a computer-readable storage medium) carrying computer-readable program code embodied in the medium.

The information may be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers). The term “carrier medium” shall also be taken to include any medium that is capable of or responsible for storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Some of the embodiments are described herein as a method or combination of elements of a method that can be implemented by a processor or a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

It will be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

The present invention will now be more fully described by reference to the following non-limiting examples.

### Example 1: Process Flow Overview

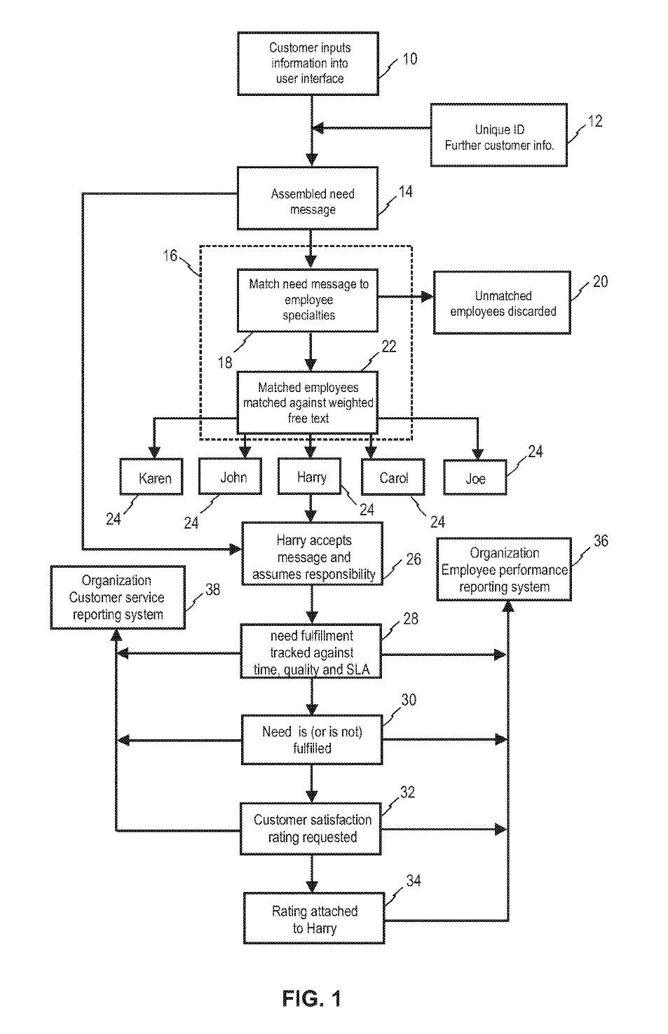

Reference is made to FIG. 1 showing a process flow diagram for one embodiment of the present invention.

The customer enters information relevant to his/her need 10 by a user interface of a browser-based form or dedicated app on his/her smart phone.

The form or app presents a customer interface screen as follows:
Hi Mary, is this you, and are your contact details correct? Click YES
Please confirm your location [drop down menu] or allow us to access the GPS location information on your phone. Location selected from drop down menu.
Please tell us what product, service or help you are looking for [search line] product/service selected
Now tell us what we can do for you [free text box] Free text entered, and click SUBMIT.

The words selectable in the search line are determined by the organization, and are designed to facilitate to identification of one or more members capable of or responsible for the attending to the customer need.

To the information input by way of the user interface, the system attaches a unique identifier 12. The identifier is used to track the customer need from the time it is received by the system to the time the need is addressed. The date and time are tracked throughout the transaction from time the customer need is first entered through to the point where the need has been met and this transaction is deemed to be completed and a customer satisfaction rating request has been asked for and the response received. The system also attaches further customer details extracted from one or more organization servers 12. The further details are obtained by reference to the customer's telephone number and include full name, the customer's status as a business user, and also the range of products and services the customer has purchased from the organization.

The information input by the user, the unique ID and the further customer details are assembled into a user need message 14.

The need message 14 is input to matching algorithms 16, the algorithms 16 configured to match the customer need to one or more customer service employees of the organization. The algorithms 16 execute a two-step process, the first step 18 matches by reference to (i) the various elements of the customer need message and (ii) the product/service specialities, skills, experience, knowledge and qualifications of each member of the organization. The product/service specialties assignable to each member are matched to the items selectable from the search line of the customer interface screen.

In identifying a member capable of or responsible for assisting the customer, the matching algorithms 16 strictly discard as potentials any member not having the required product/service specialty 20. The remaining members are then assessed by the second step 22 of the algorithms 16 against the free text entered by the customer to identify one or more member who is/are likely to be better able to address the customer need.

Five employees 24 are found by the algorithms 16 to be capable of or responsible for addressing the enquiry.

All employees 24 have the option of accepting responsibility for the need message 14, and will typically do so if he or she is capable of or responsible for addressing the need. Where the employee refuses the message (not shown) the message is routed to a second employee identified by the algorithms (not shown). Once the request is accepted by one member who then becomes responsible and is held accountable for the customer need, the notification of the need disappears from the desktops, user screens or other notification methods of the other four employees.

Acceptance of responsibility by Harry 26 triggers the routing of the need message 14 to his computer, and also tracking of progress of the fulfilment of customer need 28. The employee attempts to fulfil the need by whatever means available (e.g. process refund, dispatch installer, send quotation). Whether or not the need is fulfilled satisfactorily 30, the customer is requested to enter a rating over one or more categories of performance (such as speed, effectiveness, demeanour) 32. In this embodiment, the system is configured to track, monitor and report on the fulfilment of customer need against time, quality, or any other organization-specific criteria such as may be defined in a service level agreement (SLA).

The customer interface shows the message:
Hi Mary, I am following up on your request for [ . . . ] which Harry was responsible for. Please let me know whether you are happy with our service by rating our performance across these categories [speed . . . effectiveness . . . demeanour] using a scale of 1 to 5

The ratings provided by the customer are attached to an electronic record of Harry34.

All employee performance related information generated at 28, 30, 32, 34 is transmitted to an organization-wide employee reporting system 36 for management review.

All customer service related information generated 28, 30, 32, is transmitted to an organization-wide customer service reporting system 38 for management review.

The system is designed to provide analytics and reporting relevant to customer relationship management, including but not exclusively, what they purchased, the other reasons they contacted the organisation via the customer service engine, their overall satisfaction, demographics relating to particular types of request, clusters of types of requests, trends in purchasing requests, areas of the country or region or wherever the organisation operates, here or overseas, that demonstrate where the organisation is performing well and gaining high customer satisfaction, areas of the country or region, particular individuals or groups of individuals who are performing to organization standards, who are performing above organisation standards and equally, those who are performing below organisation standards.

This information has a multitude of high value uses to the organisation from marketing products and services to customers based on their requests and needs, ensuring that the organisation has the right skills and competencies in the right locations, identifying centres of excellence, identifying locations or parts of the organisation that are not meeting customer needs (i.e. receiving consistently less than optimal customer feedback ratings), where there are skills shortages and who may need further training or upskilling, whether the internal benchmarks are satisfactory or require amendment, and how the performance of the organisation in terms of customer satisfaction compares to an organisation's competitor, among many other uses for the data generated by the system.

This information can be made available to delegated personnel, to specific managers by name or role, by location and/or seniority and so on. Privacy requirements are built into the system to safeguard the customers, the individual members, and the organisation as a whole.

1. A system for transmitting a customer need message to a target member of an organization, the system comprising:
a first processor-enabled device configured to create the customer need message,
a second processor-enabled device configured to receive the customer need message,
a database comprising:
(i) contact details for a plurality of members of an organization, the plurality of members being potentially capable of or responsible for addressing the customer need, and
(ii) for each of the plurality of members of the organization, one or more customer need capabilities,
wherein the system is configured such that, in use, a string of the customer need message is used to interrogate the database to identify a target member of the organization capable of or responsible for addressing the customer need, and the customer need message is transmitted to the target member capable of or responsible for addressing the customer need.

2. The system of claim 1 wherein the customer need capabilities include one or more of: a product and/or service specialty, a technical skill, experience, knowledge, a qualification, a language spoken and/or written, a location, and a service rating.

3. The system of claim 1 wherein the database comprises 2, 3, 4, 5, 6, 7, 8, 9, 10 or more customer need capabilities for at least one of the plurality of members on the database.

4. The system of claim 1 wherein the database comprises 2, 3, 4, 5, 6, 7, 8, 9, 10 or more customer need capabilities for most or substantially all of the plurality of members on the database.

5. The system of claim 1 wherein the interrogation of the database is for a combination of any 2, 3, 4, 5, 6, 7, 8, 9, 10 or more customer need capabilities.

6.-8. (canceled)

9. The system of claim 1 wherein the customer need message comprises a text string.

10. The system of claim 1 wherein the customer need message comprises free text entered by a customer, or a customer assistant.

11. The system of claim 1 wherein the customer need message is in the form of an email, a web page enquiry, voice or a text message.

12. The system of claim 1 wherein the interrogation step is performed by reference to the free text entered by the customer or customer assistant.

13. The system of claim 1 configured to allow the rating of the target member capable of or responsible for addressing the customer need.

14. A computer-implemented method for transmitting a customer need message to a target member of an organization, the method comprising the steps of:
providing a first processor-enabled device configured to create the customer need message,
providing a second processor-enabled device configured to receive the customer need message,
providing a database comprising:
(i) contact details for a plurality of members of an organization, the plurality of members being potentially capable of or responsible for addressing the customer need, and
(ii) for each of the plurality of members of the organization, one or more customer need capabilities,
transmitting a customer need message from the first processor-enabled device to the second process-enabled device,
interrogating the database with a string of the customer need message to identify a target member of the organization capable of or responsible for addressing the customer need, and
transmitting the customer need message to the target member of the organization capable of or responsible for addressing the customer need.

15. The method of claim 14 wherein the customer need capabilities include one or more of: a product and/or service specialty, a technical skill, experience, knowledge, a qualification, a language spoken and/or written, a location, and a service rating.

16. The method of claim 14 wherein the database comprises 2, 3, 4, 5, 6, 7, 8, 9, 10 or more customer need capabilities for at least one of the plurality of members on the database.

17. The method of claim 14 wherein the database comprises 2, 3, 4, 5, 6, 7, 8, 9, 10 or more customer need capabilities for most or substantially all of the plurality of members on the database.

18. The method of claim 14 wherein the interrogation of the database is for a combination of any 2, 3, 4, 5, 6, 7, 8, 9, 10 or more customer need capabilities.

19.-21. (canceled)

22. The method of claim 14 wherein the customer need message comprises a text string.

23. The method of claim 14 wherein the customer need message comprises free text entered by a customer, or a customer assistant.

24. The method of claim 14 wherein the customer need message is in the form of an email, a web page enquiry, voice, or a text message.

25. The method of claim 23 wherein the interrogation step is performed by reference to the free text entered by the customer or customer assistant.

26. The method of claim 14 comprising the step of the customer rating the target member capable of or responsible for addressing the customer need.
